(19) United States
(12) Patent Application Publication
(10) Pub. No.: US 2005/0126630 A1
(43) Pub. Date: Jun. 16, 2005

(54) Automatic freeze protection system for plumbing systems

(76) Inventor: John D. Swan, Bend, OR (US)

Correspondence Address: GLENN C. BROWN, PC, 777 NW WALL STREET, SUITE 308, BEND, OR, 97701, US

(21) Appl. No.: 10/961,682

(22) Filed: Oct. 8, 2004

Related U.S. Application Data
(63) Continuation-in-part of application No. 10/420,213, filed on Apr. 21, 2003, now abandoned.

(51) Int. Cl. G05D 7/00

(52) U.S. Cl. 137/80

(57) ABSTRACT

A system operable to introduce antifreeze into the hot and cold water systems of a location responsive to a controller. The controller is operated manually. The antifreeze system is portable so that a single system may be used at multiple locations.

### RELATED APPLICATIONS

This application is a Continuation-In-Part of U.S. Ser. No. 10/420,213.

### BACKGROUND OF THE INVENTION

1. Technical Field

This invention is related to domestic plumbing systems, and in particular to an apparatus and method for protecting a home or other building from the extensive damage that can result from the freezing and resulting bursting of pipes within walls and ceilings of a building. The apparatus is portable such that one apparatus may be utilized in several locations.

2. Field of the Invention

A typical domestic plumbing system receives water from a municipal supply system or a well, and then distributes the water as hot and cold water to fixtures throughout the house. The piping that makes up the plumbing system is installed within the walls and ceilings of the building for cosmetic purposes. Such systems work very well, and provide reliable service under most conditions. One potential problem with such systems arises if and when the heating system in the building fails, and the internal temperature of the building falls below freezing. If this occurs while the building is unoccupied, the pipes can freeze and burst, causing extensive damage to the building. The damage can be particularly severe if the water service to the building has not been turned off at the supply valve, in which case water will continue to flow into the building until the leak is discovered hours or even days later.

### BRIEF SUMMARY OF THE INVENTION

This invention addresses this problem by providing a plumbing system that includes an antifreeze dispensing apparatus that can be activated to inject a predetermined amount of antifreeze into the plumbing system and prevent the freezing of the pipes and fixtures. The antifreeze is a nontoxic antifreeze that is approved for domestic use, and that can be readily flushed from the system using only fresh water form the normal supply. In another aspect of the invention, the apparatus senses when the temperature in the building has dropped to freezing and automatically shuts the water supply valve to the plumbing system. In yet another aspect of the invention, the major components of the apparatus are portable so that a single apparatus may be utilized in several different locations. These and other features of the invention will be described in greater detail be reference to the drawings.

### BRIEF DESCRIPTION OF THE DRAWINGS

The nature, principle and utility of the present invention will be clearly understood from the following detailed description when read in conjunction with the accompanying drawings, wherein:

FIG. 1 is a schematic drawing of a typical domestic plumbing system including various domestic appliances and fixtures, and the required hot and cold water supply lines.

FIG. 2 is a schematic drawing of a domestic plumbing system according to a preferred embodiment of the present invention.

FIG. 3 is a front view of a system controller.

FIG. 4 is an enlarged perspective view of connections between the bypass valve assembly, the water heater and the water supply shown in FIG. 1.

FIG. 5 is a partial cut away view of the bypass valve.

FIG. 6 is a perspective view of the portable antifreeze protection system.

FIG. 7 is a perspective view of the portable antifreeze protection system as shown in FIG. 6 with the cover in place.

FIG. 8 is a front view of the quick connect winterize valve.

FIG. 9 is a front view of the hot water heater bypass valve.

The drawings are for illustrative purposes only and are not drawn to scale. In the drawings, the same numbers are used for the same part or portion throughout the drawings.

### DETAILED DESCRIPTION OF PREFERRED EMBODIMENTS

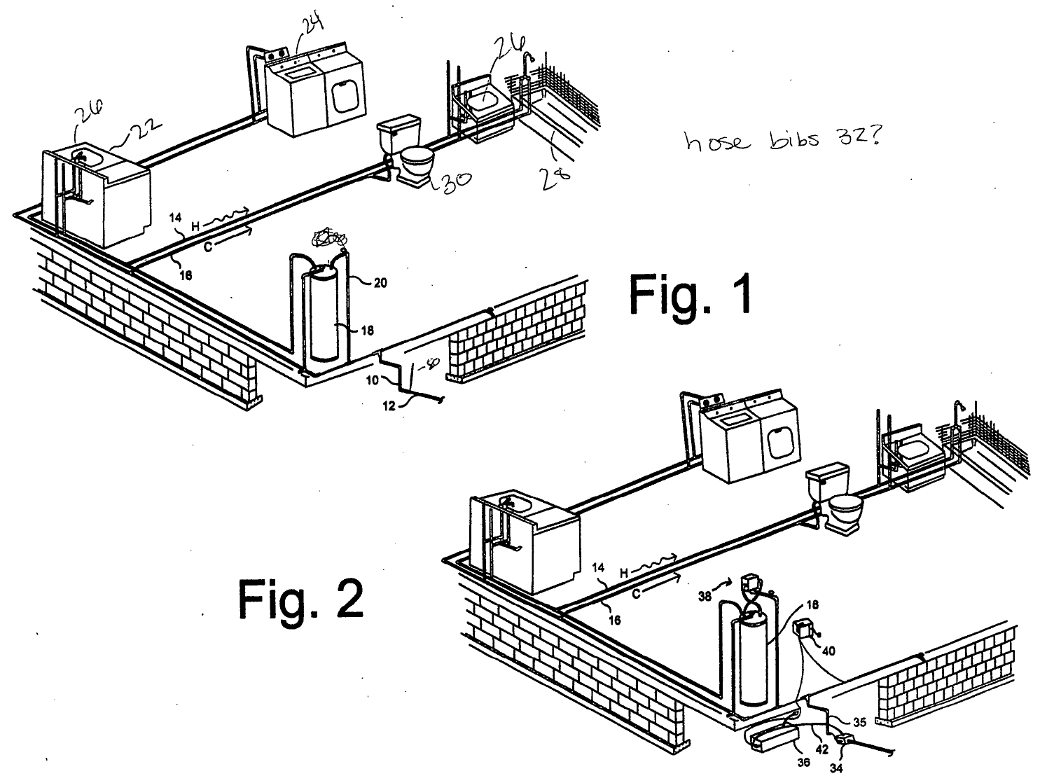

Turning now to FIG. 1, a typical domestic plumbing system includes a water supply 10, a water supply cut-off valve 12, backflow preventer, and separate hot and cold water supply piping systems 14 and 16 respectively. The hot water system 14 includes a hot water heater 18, a cold water supply 20 to the water heater 18, and a hot water supply piping system to supply hot water to appliances such as the dishwasher 22, clothes washer 24, sinks 26 in the bathrooms and kitchen, and bathtubs 28. The cold water supply piping system 16 supplies cold water to each of these same appliances and fixtures, and also to toilets 30 and hose bibs 32.

In one preferred embodiment of the invention, shown in FIG. 2, a freeze protection system includes, in addition to the components enumerated for the typical domestic plumbing system, a cold water supply valve controller 34, an antifreeze storage tank assembly 36, a bypass valve assembly 38, and a controller assembly 40. The water supply valve controller 34 includes a water supply shut off valve (not shown). An antifreeze supply line 42 connects water supply valve controller 34 to the antifreeze storage tank assembly 36. The antifreeze storage tank assembly 36 includes a pump (not shown) to dispense antifreeze within the storage tank assembly 36 through line 42 to the water supply controller valve 34 and into the water supply line 35. The pump is preferably a low voltage pump that is supplied with low-voltage current from a transformer connected to the building's electrical system (not shown) under normal operation. In the event of a power outage, the storage tank assembly 42 includes a backup battery (not shown) for operating the pump.

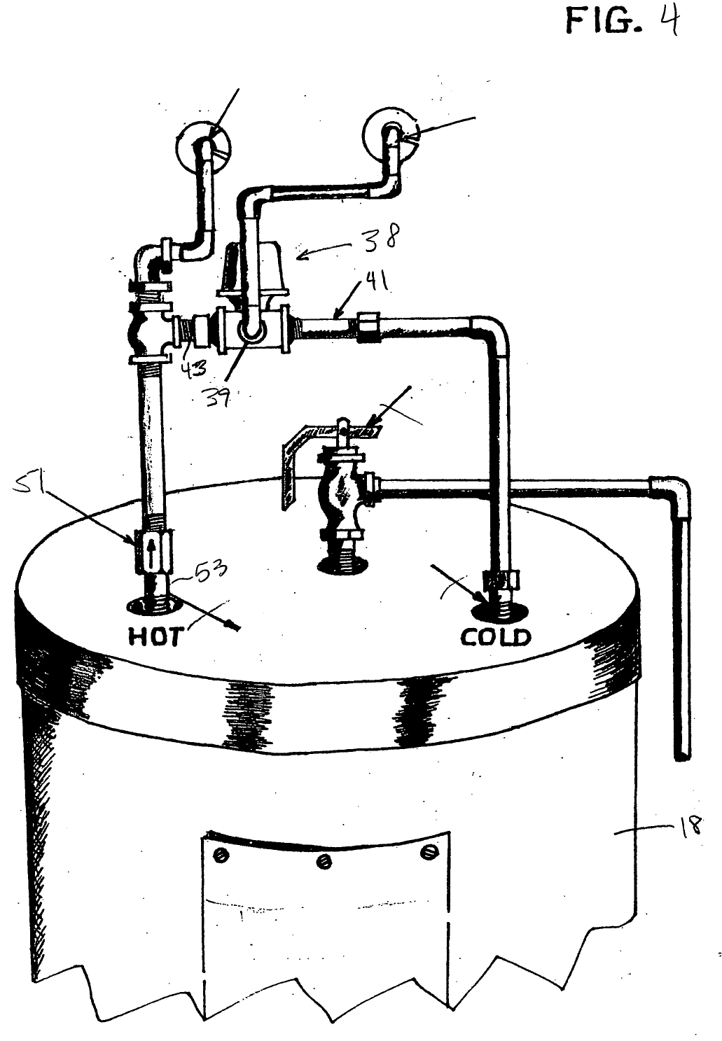

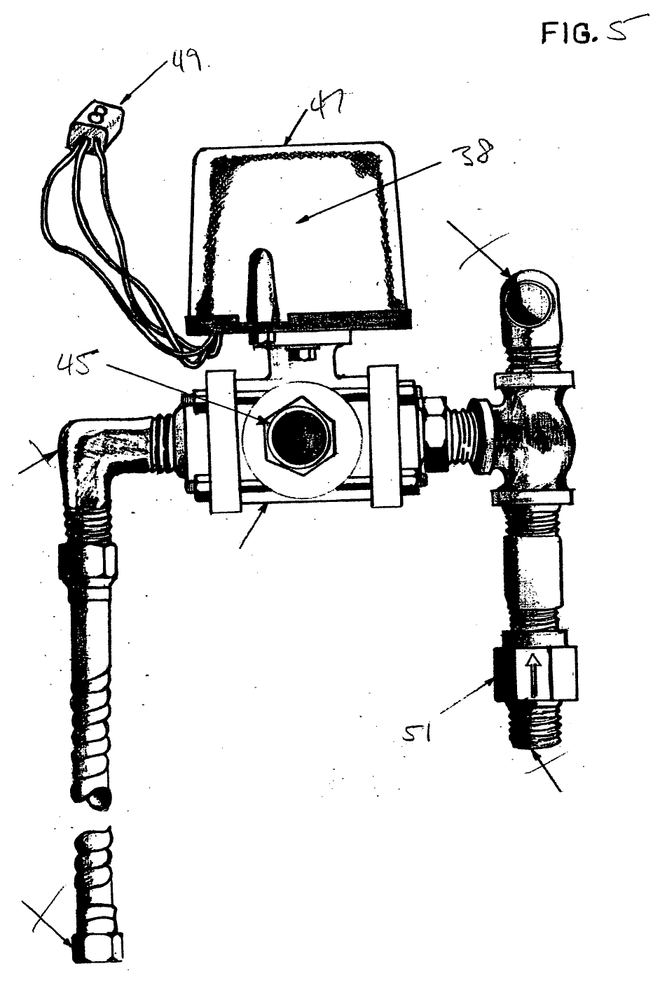

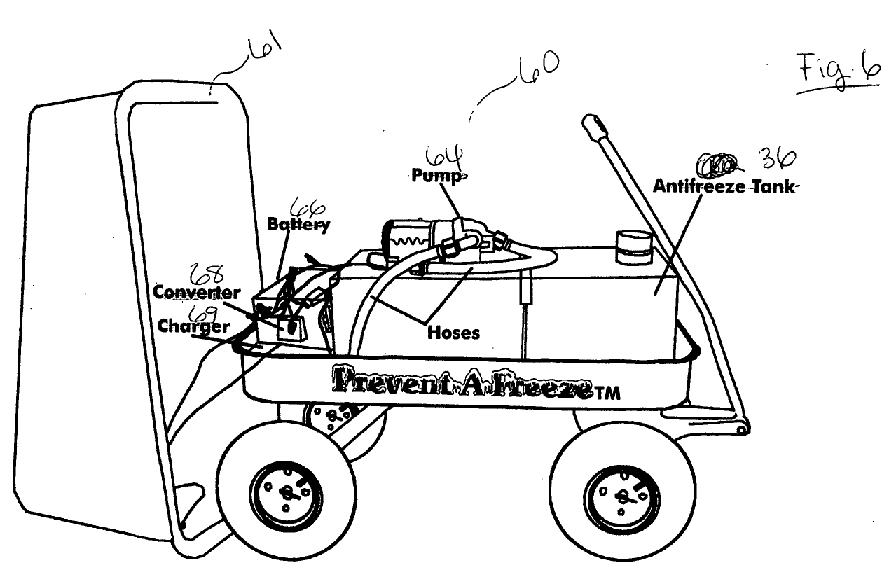

Referring to FIGS. 4 and 5, bypass valve assembly 38 includes an electrically operated three-way valve that can be configured to direct a supply of cold water into the water heater 18 under normal operation, and to bypass the water heater 18 and redirect cold water directly into the hot water piping system 16. Bypass valve 38 in the preferred embodiment is a three way ball valve with its inlet 39 connected to the cold water inlet line from the water supply controller valve 34. One outlet 41 of bypass valve 38 directs cold water to the hot water heater 18 under normal conditions. A second outlet 43 directs cold water to bypass water heater 18 and go directly into the hot water system of the building. This configuration is used to introduce antifreeze into the hot water system of the building. A check valve 51 is installed between the water heater hot water outlet 53 and bypass valve 38 to prevent backflow into the water heater discharge from the bypass valve. Referring to FIG. 5, bypass valve 38 includes a ball assembly 45 that is rotated between the first and second configurations by actuator 47. Actuator 47 is connected by wires 49 to controller assembly 40, which operates the bypass valve as described below.

The controller assembly 40 is preferably an electronic as shown FIG. 3. Controller 40 includes an outside temperature monitor 42, an antifreeze level indicator 44, an inside temperature monitor 46, a switch 48 to initiate the winterization process, a switch 50 to activate the bypass valve assembly 38, a switch 52 to activate the battery backup for antifreeze injection pump, and a water damage control switch 54 to activate the water supply controller valve 34 in order to isolate the plumbing system from the water supply system if temperatures drop to −30° F.

The operation of the system will now be described. Under normal operation, water supply controller 34 directs water from the water supply system to the plumbing system. Cold water is directed into the cold water piping system 16, and also through bypass valve assembly 38, hot water heater 18 and into the hot water piping system 14.

When the building is going to be unoccupied for a period of time in which it would be possible for the plumbing system to be exposed to freezing temperatures, the user presses the bypass switch 50, followed by the winterize switch 48. The system is activated to configure bypass valve assembly 38 to redirect water away from the hot water heater and directly into the hot water piping system 14. The system then activates the antifreeze pump to supply antifreeze from storage tank assembly 42 to the water supply controller, which injects the antifreeze into the water entering the plumbing system of the building. Water valves on the appliances and fixtures are then opened to permit the water/antifreeze solution to flow through and fill the plumbing system, and are then closed. The hot and cold water piping systems are then protected from freezing temperatures. Applicant has found that a ratio of 50% propylene glycol is suitable for protecting the system to a temperature of about −50 F. A higher concentration of antifreeze can be obtained by adjusting the water supply controller 34 to inject a greater amount of antifreeze into the water entering the system. In this way the system can be protected to a temperature of −60° F. Once the plumbing system has been flushed with the antifreeze mixture, the valves on the appliances and fixtures are closed. The water supply controller 34 is then activated again, and shuts the water supply valve, protecting the system in the event of a leak in the system during the owner's absence. The winterize injection switch also deactivates the pump in the antifreeze storage assembly 36. The water heater can be turned off and drained since it is isolated from the rest of the system.

When the building is to be reoccupied, the bypass switch 50 is activated, configuring the bypass valve 38 to its bypass operating configuration. The winterize switch 48 is activated to normal flow to open the water supply valve. The water valves at each appliance are opened to permit fresh water to completely flush the antifreeze from the system in preparation for normal use of the building. After flushing is complete, the bypass 50 is activated to normal flow position and the water heater will fill at this time.

In the preferred embodiment the system is activated and controlled by a 12 volt electrical system. In other embodiments some or all of the system configuration and activation can be done manually.

Some functions of the system can be activated individually. For example, if the building is to be unoccupied, but freezing is not a concern the water damage control switch 54 can be activated to shut off the water supply to the building while unoccupied. If it is necessary to service the water heater, the bypass valve can be operated separately to isolate the water heater from the rest of the system. Finally, if power to the building is interrupted, the water damage control 54 will activate closing the flow of water supply.

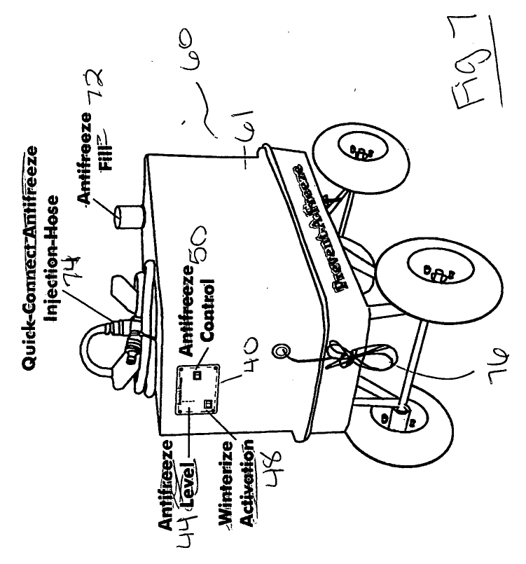

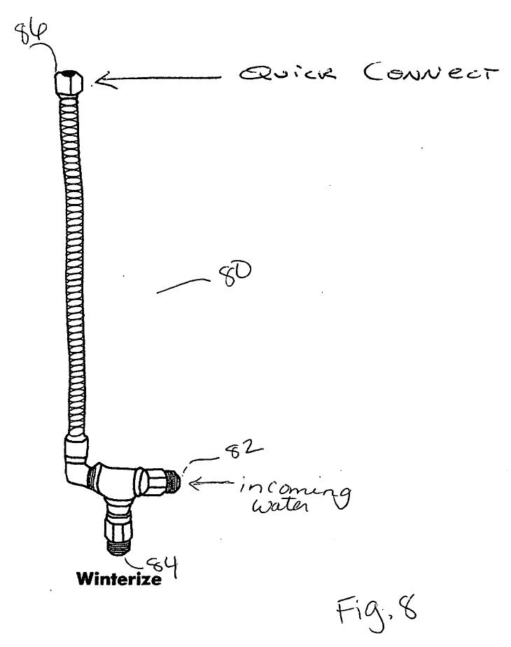

In an alternate embodiment, the major components of the apparatus are assembled and mounted on a cart so that a single apparatus may be utilized in several locations. As shown in FIG. 6, the antifreeze storage tank 36, the pump 64, the battery 66, a converter 68 and a charger 69 are included in a portable unit 60. The portable unit 60 includes a cover 61. As shown in FIG. 7, when the cover 61 is engaged on the portable unit 60, controller 40 is accessible. The controller 40 is operated manually and generates electrical signals to configure the system. The controller 40 includes an antifreeze level indicator 44, a switch 48 to initiate the winterization process, and an antifreeze switch 50, as discussed in more detail in reference to FIG. 3. The portable unit 60 also includes an antifreeze fill port 72 and an antifreeze injection hose 74.

The portable unit 60 may be plugged in to an electrical outlet at the desired location with cord and plug 76. In the event of a power failure, the controller 40 will direct the back-up battery 66 to operate the pump 64.

One advantage of the portable unit 60 is that one unit may be utilized in several different locations. For example, it may be desirable to winterize several buildings in several different locations. The portable unit 60 may also be used winterize the plumbing system of a vehicle, such as an RV or a boat. The various locations would have a quick connect assembly as a permanent fixture. The portable unit 60 can easily be connected to the quick connect assembly in order to perform the winterization process.

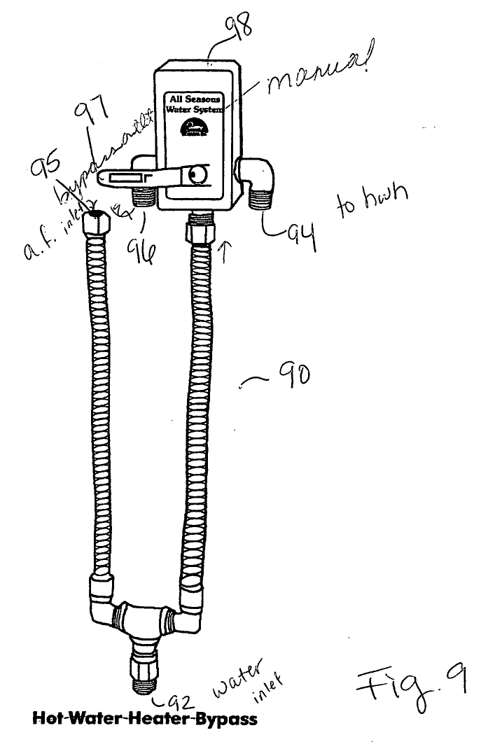

Quick connect assembly 80 is depicted in FIG. 8. The incoming water supply line is connected at inlet 82 and the water supply exits at outlet 84. Outlet 84 is connected to the plumbing system of the building or vehicle. The antifreeze injection hose 74 of the portable unit 60 can be connected at inlet 86 for performing the winterization process.

The building or vehicle may also have an electric hot water heater bypass valve as depicted in FIGS. 4 and 5. Alternatively, the hot water heater bypass valve may be manual, such as the valve assembly 90 depicted in FIG. 9. In the manual hot water heater bypass valve assembly 90, the water supply enters at inlet 92. Under normal operation, the water supply exits the bypass valve 98 and enters the hot water heater at outlet 94. For winterization purposes, the lever 97 is activated so that antifreeze enters the assembly 90 at the inlet 95, passes through the valve 98 and enters the plumbing system at outlet 96, thereby bypassing the hot water heater.

The operation of the portable system 60 will now be described. Under normal operation, water is directed from the water supply inlet 82 of the quick connect assembly 80 to the plumbing system of the location via outlet 84. Quick connect assembly 80 is a permanently installed fixture at the location. Cold water is directed into the cold water piping system, and also through bypass valve assembly 90, hot water heater and into the hot water piping system.

When the location is going to be unoccupied for a period of time in which it would be possible for the plumbing system to be exposed to freezing temperatures, the user connects the antifreeze injection hose 74 of the portable unit 60 to the quick connect inlet 86. Then, the user switches the lever 97 on the hot water heater to the bypass position so that water is redirected away from the hot water heater and directly into the hot water piping system. Then, the user presses the antifreeze switch 50, followed by the winterize switch 48, so that the antifreeze pump 64 supplies antifreeze from storage tank 36 to the plumbing system of the location. Water valves on the appliances and fixtures are then opened to permit the water/antifreeze solution to flow through and fill the plumbing system, and are then closed. The hot and cold water piping systems are then protected from freezing temperatures. Applicant has found that a ratio of 50% propylene glycol is suitable for protecting the system to a temperature of about −50 F. Once the plumbing system has been flushed with the antifreeze mixture, the valves on the appliances and fixtures are closed. The winterize injection switch then deactivates the pump 64 in the portable unit 60. The water heater can be turned off and drained since it is isolated from the rest of the system.

When the location is to be reoccupied, the lever 97 on the hot water heater bypass valve 90 is switched to the bypass operating configuration. The winterize switch 48 is activated to normal flow to open the water supply valve. The water valves at each appliance are opened to permit fresh water to completely flush the antifreeze from the system in preparation for normal use of the building. After flushing is complete, the lever 97 on the hot water heater bypass valve 90 is switched to the normal flow position and the water heater will fill at this time.

The antifreeze solution can be any suitable solution approved for domestic potable water systems. Applicant has identified prop glycol, available from Dow Chemical, as one such preferred antifreeze solution.

While the invention has been described by reference to the foregoing preferred embodiments, the invention is not intended to be limited thereby. Those of skill in the art will understand that numerous modifications and variations are possible without departing from the scope of the following claims.

1. A plumbing system for a first location, the plumbing system including hot and cold water distribution systems, one or more water-using appliances connected to the hot and cold water distribution systems, a water supply connected to the hot and cold water distribution systems, and a water heater, the improvement comprising:
a liquid injector operable to inject a liquid antifreeze into the plumbing system;
a bypass check valve assembly connected to the cold water distribution system, the hot water distribution system, and the water heater, the bypass assembly operable to a first configuration connecting the water supply to an inlet of the water heater, and operable to a second configuration connecting the water supply directly to the hot water distribution system and bypassing the water heater;
an antifreeze tank including an antifreeze reservoir and a pump, the antifreeze tank operable to pump antifreeze from the reservoir to the liquid injector; and,
a controller in communication with the antifreeze tank and the liquid injector, the controller operable to activate the antifreeze tank to pump liquid from the reservoir to the liquid injector, and to operate the liquid injector to inject antifreeze into the plumbing system,
wherein the antifreeze reservoir and the pump are portable to a second location.

2. A plumbing system according to claim 1 wherein the plumbing system is connected to a primary power source, and wherein the controller is operable to configure the plumbing system into a second predetermined configuration responsive to a failure of the primary power source, the second predetermined configuration including the plumbing system connected to a secondary power source.

3. A plumbing system according to claim 1 wherein the controller is operated manually and generates electrical signals to configure the system.

4. A plumbing system according to claim 1 wherein the bypass assembly includes a three-way valve.

5. A plumbing system according to claim 1, wherein the liquid injector and the bypass check valve assembly are mounted on a plumbing system of a building.

6. A plumbing system according to claim 1, wherein the liquid injector and the bypass check valve assembly are mounted on a plumbing system of a vehicle.
